(19) United States
(12) Patent Application Publication
(10) Pub. No.: US 2005/0209908 A1
(43) Pub. Date: Sep. 22, 2005

(54) Method and computer program for efficiently identifying a group having a desired characteristic

(76) Inventor: Alan Weber, Cleveland, MO (US)

Correspondence Address: Hovey Williams LLP, Suite 400, 2405 Grand Blvd., Kansas City, MO, 64108, US

(21) Appl. No.: 10/802,204

(22) Filed: Mar. 17, 2004

(51) Int. Cl. G06F 17/60

(52) U.S. Cl. 705/10

(57) ABSTRACT

A method and computer program for efficiently identifying at least one group having a desired characteristic by using coded entry information in a statistically predictive segmentation model (24) is disclosed which comprises accessing a plurality of entries (14) having contact data (16), coding each entry with at least one first identifier (18) representing the number of times the entry has participated in a plurality of activities (20), coding each entry with at least one second identifier (22) representing the recency of the entry's participation in the activities, utilizing the statistically predictive segmentation model (24) to categorize the entries (14) into groups based on the coding of the entries (20), and identifying at least one group which includes the desired characteristic. The statistically predictive segmentation model (24) includes any of several techniques known in the art, including, but not limited to, Chi-Square Automatic Interaction Detection (CHAID), Exhaustive CHAID, or Classification and Regression Tree (C&RT).

### BACKGROUND OF THE INVENTION

1. Filed of the Invention

The present invention relates to a method and computer program for efficiently identifying at least one group having a desired characteristic. More particularly, the invention relates to a method and computer program for efficiently identifying at least one group having a desired characteristic by using coded entry information in a statistically predictive segmentation model.

2. Description of the Prior Art

Marketers, businesses, individuals, and other entities commonly attempt to target with communication a portion of the population that possess a desired characteristic that is relevant to the entity. For instance, retailers often send mass mailings to particular potential customers, businesses often identify their previous customers in an attempt to increase sales, marketers often identify customers who have previously purchased products, city symphonies often identify people who previously donated to the arts, etc. Unfortunately, such prior art methods require communications to a large number of individuals, and thus are costly and ineffective due to the low response rates achieved. Particularly, the costs incurred in implementing these methods often exceeds the monetary value of the increased sales.

To overcome this limitation, additional prior art methods and computer programs have been developed, such as cross-tab reports and demographic data overlays, that attempt to more accurately target a group having a desired characteristic. These additional prior art methods and computer programs are becoming increasing popular due to the low cost of computing resources and the accessibility of information relating to consumers, individuals, businesses, and other groups.

However, these additional methods and computer programs still suffer from a number of inefficiencies and inaccuracies which often require a user to spend considerable resources communicating with a targeted group due to the low response rate found in the group.

For instance, prior art cross-tabs reports have been developed which compare at least two separate lists of customers, individuals, groups, etc, and identify which customers, individuals, groups, etc, are found in the first list and not in the second list. A cross-tab report developed for a city symphony may compare a list of opera subscribers, a list of ballet subscribers, and a list of symphony subscribers to determine which individuals subscribe to the opera and ballet, but not the symphony. These individuals may then be targeted to subscribe to the symphony. Cross-tab reports suffer from similar inefficiencies and inaccuracies as do the simple prior art methods, as the response rate for any targeted group is minimal due to the small number of factors considered by the method and the limited number of categories created by the method.

Other additional prior art methods and computer programs specifically target a group having a desired characteristic based on the number of activities each member of the group has been involved with. For instance, a city symphony may target a group which has participated in at least three art related activities in an effort to find a group which has the desired characteristic of being likely to subscribe to the symphony. Such methods also suffer from low response rates among the target group due to the limited number of factors considered and limited number of categories available.

Furthermore, other prior art methods and computer programs specifically target a group based on demographic characteristics, such as an individual's age, income, geographic location, etc. Such methods and programs are generally inaccurate due to the large number of individuals in each demographic group and thus, these methods also suffer from the same disadvantages as discussed above due to the limited number of factors considered.

Accordingly, there is a need for an improved method and computer program for efficiently identifying at least one group having a desired characteristic that overcomes the limitations of the prior art. More particularly, there is a need for a method and computer program which accurately and effectively and efficiently targets a group of individuals having a desired characteristic.

Furthermore, there is a need for a method and computer program for efficiently identifying at least one group having a desired characteristic which does not require the size of the targeted group to be burdensome or require an excessive amount of communication with the targeted group.

There is yet a further need for a method and computer program for efficiently identifying at least one group having a desired characteristic which accurately and effectively identifies the group having the desired characteristic by using a combination of factors.

### SUMMARY OF THE INVENTION

The present invention solves the above-described problems and provides a distinct advance in the art efficiently identifying at least one group having a desired characteristic. More particularly, the present invention provides a method and computer program for efficiently identifying at least one group having a desired characteristic by using coded entry information in a statistically predictive segmentation model.

The method and computer program of the present invention broadly includes the steps of (a) accessing a plurality of entries having contact data, (b) coding each entry with at least one first identifier representing the number of times the entry has participated in a plurality of activities, (c) coding each entry with at least one second identifier representing the recency of the entry's participation in the activities, (d) utilizing a statistically predictive segmentation model to categorize the entries into groups based on the coding of the entries, and (e) identifying at least one group which includes the desired characteristic.

The desired characteristic may be an interest in a certain product or service, a substantial probability of a future purchase of a certain product or service, a past purchase of a certain product or service, a minimum response rate, a rate of response of a group targeted with communication, a rate of response for an individual within the target group, or any other desirable or undesirable element. Thus, a group or an individual entry within the group may possess the desired characteristic.

Each entry comprises contact data which preferably includes the entry's contact information, such as name and mailing address, an indication of the total number of times the entry has participated in a plurality of activities, the number of times the entry has participated in each activity, the recency of the entry's participation in each activity, and an indicator relating to the desired characteristic.

The activities may be any activities which are relevant to the desired characteristic and are selected based on the desired characteristic and the information available to the method or computer program. For instance, if the desired characteristic is a likelihood of subscribing to the city symphony, the plurality of activities may include the city symphony, jazz concerts, family concerts, opera, donation to the arts, etc.

Each entry is coded with at least one first identifier representing the number of times the entry has participated in a plurality of activities and at least one second identifier representing the recency of the entry's participation in the activities. Alternatively, each entry may be coded with at least one first identifier representing the entry's participation in each activity and at least one second identifier representing the recency of the entry's participation in each activity. For instance, if an entry had participated in the symphony only once, in the year 2003, the entry is coded with a first identifier of SYMC=1 and a second identifier of SYMY=3.

Each entry may be also be coded with additional identifiers representing the amount of money the entry has spent for each activity, identifiers representing the total number of activities the entry has participated in, and identifiers representing the entry's demographic data, such as the age, income, geographic location, or gender of the entry.

The statistically predictive segmentation model 28 may be any model that utilizes the coded entry information as predictor variables (dependent variables) to create a specific estimate value (an independent variable) for each entry based on the indicator relating to the desired characteristic. The specific estimate value may be the desired characteristic or the desired characteristic may be determined by the value of the specific estimate value.

The statistically predictive segmentation model includes any of several techniques known in the art, including, but not limited to, Chi-Square Automatic Interaction Detection (CHAID), Exhaustive CHAID, or Classification and Regression Tree (C&RT). CHAID is generally the preferred technique. However, Exhaustive CHAID is preferred when the number of entries or activities is limited and C&RT is preferred when the entries are coded with ordinal indicators, such as when a Y or N is used to indicate participation instead of a numerical value.

The statistically predictive segmentation model categorizes the entries into nodes based on the predictor variables. Each node, and each entry within each node, may be assigned the specific estimate value. The specific estimate value may be the desired characteristic, such when a node has a specific estimate value which represents a desired predicted response rate. Thus, the group or groups having the desired characteristic may be identified based on the specific estimate value.

The method and computer program as described herein has numerous advantages over the prior art. First, the method and computer program is substantially more efficient and accurate than the prior art due to the coding of the entries and the use of a statistically predictive segmentation model. Second, the method and computer program of the present invention identifies a group having a desired characteristic without requiring the size of the group to be burdensome. Third, the method and computer program of the present invention identifies groups having a more frequent response rate than prior art methods, thus reducing the number of communications required to target the group.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a plan view of computing equipment utilized by the method and computer program of the present invention;

FIG. 2 is a flow chart showing some of the steps performed when implementing the method and computer program of the present invention;

FIG. 3 is a table showing an example listing of a plurality of entries accessed by method and computer program;

FIG. 4 is a table showing an example listing of the coded plurality of entries used by the method and computer program;

FIG. 5 is a flow chart showing some of the steps performed when implementing a statistically predictive segmentation model utilized by the method and computer program; and

FIG. 6 is a tree diagram showing an example output of the statistically predictive segmentation model of the method and computer program.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

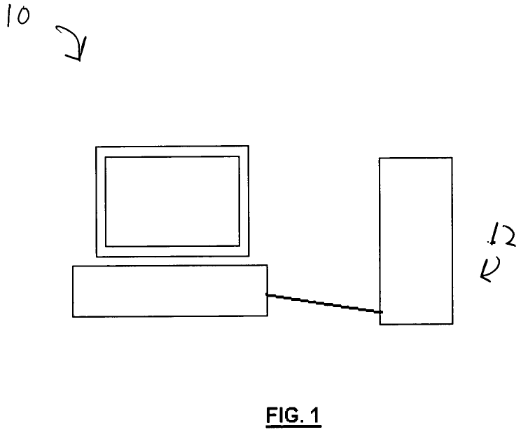

The computer program and method of the present invention for efficiently identifying at least one group having a desired characteristic is preferably implemented by using computing equipment 10 as shown in FIG. 1. The computing equipment 10 may include computing devices, computer software, hardware, firmware, or any combination thereof. In a preferred embodiment, however, the computing equipment 10 includes any computing device such as a personal computer, a network computer running Windows NT, Novel Netware, Unix, or any other network operating system, a computer network comprising a plurality of computers, a mainframe or distributed computing system, a portable computing device, or any combination thereof. The computing equipment also preferably includes internal or external memory 12 for storing information, such as electronic files, directories, listings, or databases.

The computing equipment 10 and computer program illustrated and described herein are merely examples of a device and a program that may be used to implement the present invention and may be replaced with other devices and programs without departing from the scope of the present invention.

The computer program described herein controls input to the computing equipment 10 and the operation of the computing equipment 10. The computer program is stored in or on a computer-readable medium residing on or accessible by the computing equipment 10 for instructing the computing equipment 10 and the other related components to operate as described herein. The computer program preferably comprises an ordered listing of executable instructions for implementing logical functions in the computing equipment 10. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The functionality and operation of a preferred implementation of the computer program is described below. In this regard, some of the described functionality may represent a module segment or portion of code of the computer program of the present invention which comprises one or more executable instructions for implementing the specified logical function or functions. In some alternative implementations, the functions described may occur out of the order described below. For example, functionalities described in succession may in fact be executed substantially concurrently, or the functionalities may sometimes be executed in the reverse order depending upon the functionality involved. Additionally, portions of the computer program and method may be implemented without the use of the computing equipment 10, as described in more detail below.

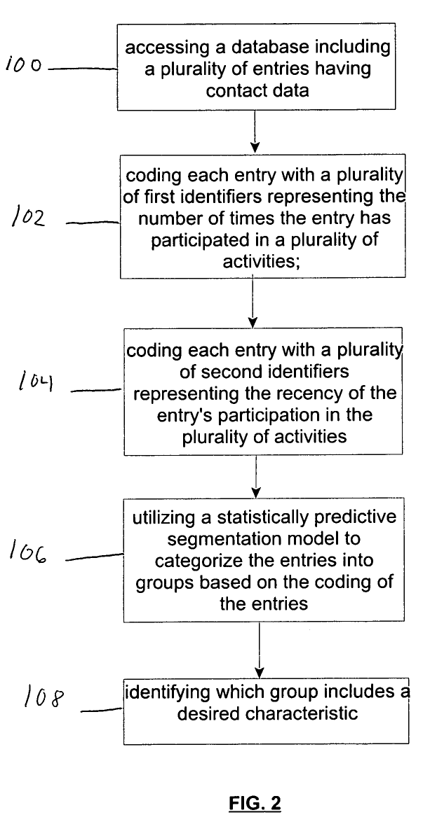

Referring to FIGS. 2-4, the computer software and method of the present invention broadly includes the steps of (a) accessing a plurality of entries 14 having contact data 16, referenced at step 100 in FIG. 2; (b) coding each entry with at least one first identifier 18 representing the number of times the entry has participated in a plurality of activities 20, referenced at step 102 in FIG. 2; (c) coding each entry with at least one second identifier 22 representing the recency of the entry's participation in the activities 20, referenced at step 104 in FIG. 2; (d) utilizing a statistically predictive segmentation model 24 to categorize the entries 14 into groups based on the coding of the entries 14, referenced at step 106 in FIG. 2; and (e) identifying at least one group which includes a desired characteristic based on the categorization of the entries 14, referenced at step 108 in FIG. 2.

The group having the desired characteristic may be targeted by a marketer, advertiser, business, charitable organization, public interest group, government organization, political group, community cultural group, etc, with mailings, e-mails, telephone calls, pages, or any other form of communication, for commercial or non-commercial purposes.

The desired characteristic may be an interest in a certain product or service, a probability of a future purchase of a certain product or service, a past purchase of a certain product or service, a minimum response rate, or any other desirable or undesirable element. For example, a community cultural group, such as a city symphony, may wish to increase the number of individuals who donate to the symphony by mailing informational material to a group of individuals who are very likely to donate, such as a group of individuals who were very likely to donate in a previous year. By targeting only the groups with the desired characteristic of being very likely to donate to the symphony in the previous year, the costs associated with mailings are decreased and the likelihood of future donations by the groups are increased. Additionally, groups which were least likely to donate may be identified and not targeted, further reducing the costs associated with the mailings.

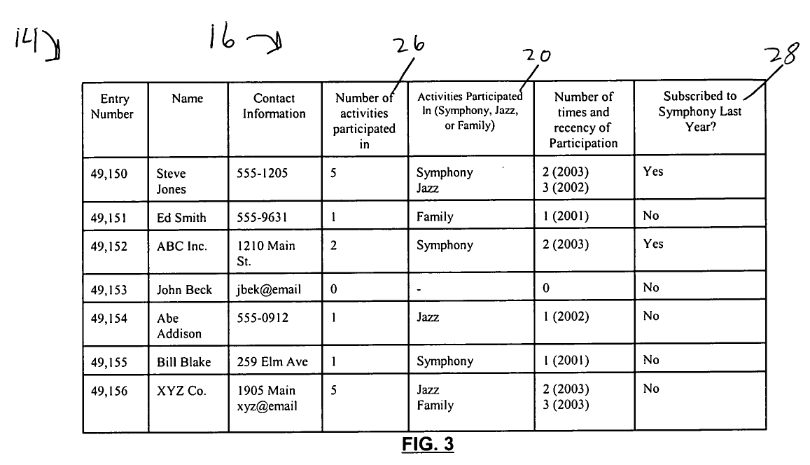

Referring to FIG. 3, the entries 14 are shown in partial list for demonstration purposes. Each entry may be an individual, a family, a group, a business entity, an organization, or any combination thereof. Each entry includes contact data 16. Preferably, the contact data 16 includes the entry's contact information, such as a mailing address, telephone number, or electronic mail address. The contact data 16 also includes an indication 26 of the total number of times the entry has participated in the activities 20, the number of times the entry 14 has participated in each activity, the recency of the entry's participation in each activity, and an indicator 28 relating to the desired characteristic, such as the entry's interest in a certain product or service, the entry's purchase of a certain product or service, the entry's past propensity to purchase a type of service, or any other information or combination of information relating to the desired characteristic. Alternatively, the indicator 28 relating to the desired characteristic may be represented by other contact data 16, such as the indication 26 of the total number of times the entry has participated in the plurality of activities 26, etc.

Additionally, the contact data 16 may the include the recency of the entry's participation in any activity, the amount of money the entry has spent on each activity, and demographic data relating to the entry, such as the age, income, geographic location, or gender of the entry. Therefore, the contact data 16 may include any information which may be attributed to the entry, thus increasing the accuracy of the method, as described below.

The activities 20 may be any activities which are relevant to the desired characteristic. For example, if a group is sought which has the desired characteristic of being likely to donate to the city symphony, the plurality of activities 20 may include the symphony, jazz concerts, and family concerts, as shown in the example of FIG. 3. Additionally, the plurality of activities 20 in this example may include the opera, popular music concerts, donations to the arts, etc. Thus, the activities 20 are selected based on the desired characteristic and the information available to the method or computer program. For instance, the activities 20 for a desired characteristic of being likely to donate to the city symphony would probably be different than the plurality of activities 20 for a desired characteristic of being likely to purchase season baseball tickets. Additionally, it is within the scope of the present invention for a single activity to be used in place of the plurality of activities 20.

The entries 14 and contact data 16 are preferably stored in a computer-readable database 30 which may be accessed by the computer program and computing equipment 10. The computer-readable database 30 may be included within the computing equipment 10, such as when the computer-readable database is stored within the internal or external memory 12 of the computing equipment or any other computer readable medium. The computer-readable database 30 may be stored separately from the computing equipment 10, such as on another accessible computer or through a network connection to another computer, such as a LAN, WAN, or the Internet.

The entries 14 and contact data 16 may be assembled from commonly available or proprietary information, such as customer or client lists, subscription information, shared databases, vendor sales information, or any combination thereof. The entries 14 and contact data 16 may be provided by an entity other than a user of the method or computer program such that the user of the method or computer program is not required to assemble or format the entries 14 and contact data 16 into a listing or a computer-readable database.

The entries 14 are sufficient in number allow the statistically predictive segmentation model 24 to effectively categorize the entries, as described below. Thus, the entries 14 preferably include at least 50,000 entries. However, the method and computer program may still function accurately and effectively if a number of entries less than 50,000 is used depending on the desired result of the method and the available information.

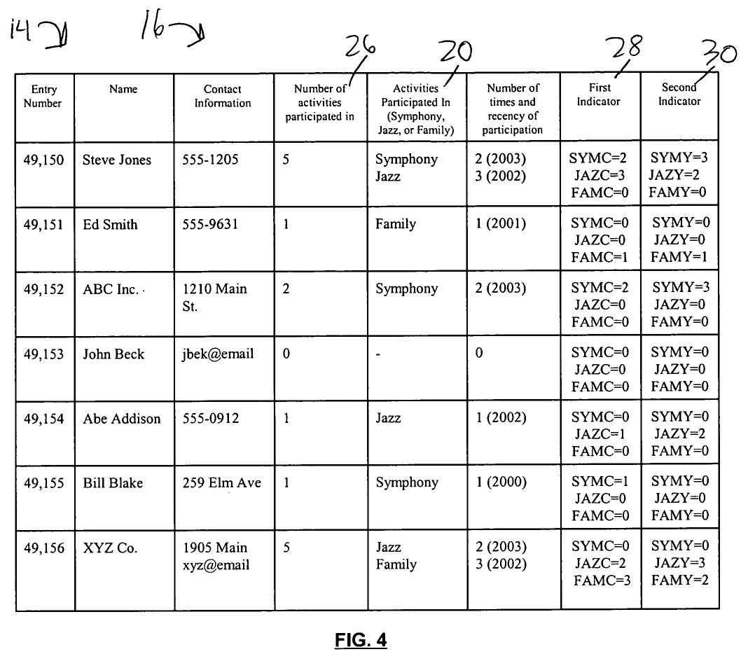

Referring to FIG. 4, the coding of each entry with at least one first identifier 18 representing the number of times the entry has participated in each activity is shown. For example, the entry “Steve Jones” has participated in the symphony two times, jazz concerts three times, and family concerts zero times, and thus has been coded with the first identifier 18 of a “SYMC=2”, “JAZC=3”, and “FAMC=0”. Alternatively, each entry may be coded with a first identifier 18 representing the number of times the entry has participated all activities 20.

The coding of the number of times the entry has participated in each activity may be limited to a certain range, such as zero through three, as an entry who has participated thirty times may be no more likely to have the desired characteristic than an entry who has participated three times. However, in some situations it may be desirable to refrain from limiting the coding to a certain range. The coding of the first identifier 18 may differ from the example provided above, such as where the first identifier 18 represents the number of times the entry has participated in each activity in a manner different than combining a phrase representing the name of the activity and a numeral indicating the number of times the entry has participated in the activity.

Still referring to FIG. 4, the coding of each entry with at least one second identifier 22 representing the recency of the entry's participation in each activity is shown. For example, the entry “Steve Jones” last participated in the symphony in 2003 and in jazz concerts in 2002. Thus, assuming the current year is 2004, the entry “Steve Jones” has been coded with “SYMY=3”, “JAZY=2”, and “FAMY=0”. Alternatively, each entry may be coded with a second identifier 22 representing the recent of the entry's participation in any activity 20.

The coding of the recency for the entry's participation in each activity may be limited to a certain range, such as zero through three, as an entry who has not participated in the last ten years may be no more likely to have the desired characteristic than an entry who has not participated in the last three years. However, in some situations it may be desirable to refrain from limiting the coding to a certain range. The coding of the second identifier 22 may differ from the example provided above, such as where the second identifier 22 indicates the recency of the entry's participation in a manner different than indicating the last year of participation.

In addition to the first identifier 18 and second identifier 22, each entry may be coded with additional identifiers. For instance, each entry may be coded with at least one third identifier representing the amount of money the entry has spent for each activity. Each entry may also be coded, in addition to or in place of the third identifier, with at least one fourth identifier representing the total number of activities the entry has participated in. Furthermore, each entry may also be coded, in addition to or in place of the third identifier or fourth identifier, with at least one fifth identifier representing the entry's demographic data, such as the age, income, geographic location, or gender of the entry. The coding of the additional identifiers may be in a manner similar to the coding of the first identifier 18 and second identifier 22, such as where a phrase is followed by a number, or the coding of the additional identifiers may be different than the coding of the first identifier 18 and second identifier 22.

The use of additional identifiers, such as the third identifier, fourth identifier, and fifth identifier allow the categorization of groups in addition to those created by the use of the first identifier 18 and second identifier 22 alone, and thus and in turn increase the efficiency and accuracy of the method, as described below in more detail.

By coding each entry with an indicator representing a behavioral element belonging to the entry, the efficiency and accuracy of the method is increased as behavioral data, such as data relating to an entry's purchases, activities, memberships, etc, is typically several orders of magnitude more effective in predicting response rates for a group than using demographic data alone. Thus, the present invention seeks to maximize the use of behavioral data when coding the entries 14, which in turn maximizes the efficiency and accuracy of the method. However, as described above, the entries 14 may be coded with behavioral data and demographic data when necessary to increase the total amount of information available to the method and further increase its efficiency and accuracy.

Although the first identifiers 18 and second identifiers 22 of FIG. 4 are shown comprising a series of letters followed by a number for ease of modeling, description, and explanation, it is possible to code the entries 14 with any type of numeric, categorical or ordinal identifier.

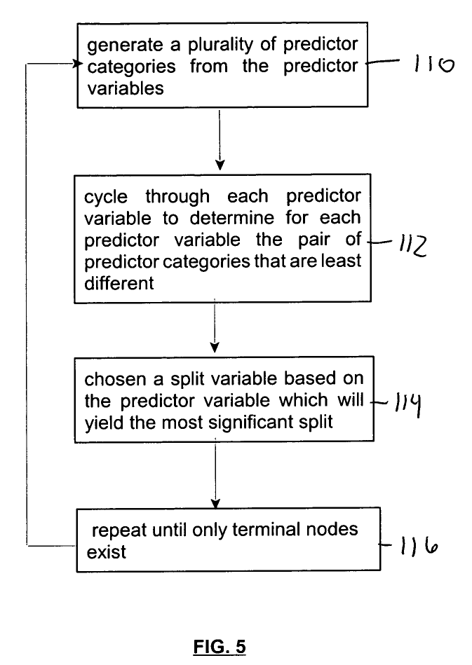

Referring to FIG. 5, the statistically predictive segmentation model 24 is utilized to categorize the entries 14 based on the coding of the entries 14. The statistically predictive segmentation model 24 may be any model that utilizes the coded entry information as a predictor variable (a dependent variable) to create a specific estimate value 38 (an independent variable) for each entry based on the indicator 28 relating to the desired characteristic. The specific estimate value 32 may be the desired characteristic or the desired characteristic may be determined by the value of the specific estimate value 32.

The statistically predictive segmentation model 24 includes any of several techniques known in the art, including, but not limited to, Chi-Square Automatic Interaction Detection (CHAID), Exhaustive CHAID, or Classification and Regression Tree (C&RT). CHAID is generally the preferred technique. However, Exhaustive CHAID is preferred when the number of entries 14 or activities 20 is limited and C&RT is preferred when the entries 14 are coded with ordinal indicators, such as when a Y or N is used to indicate participation instead of a numerical value.

The segmentation model 24 categorizes the entries 14 by forming a tree structure, either binary or non-binary, having a plurality of nodes 24 each including at least one entry. The tree structure may allow more than two nodes to attach to a single node and each node found in the tree structure may branch into additional nodes. A terminal node 36 is a node which does not branch into additional nodes. Terminal nodes 36 are mutually exclusive and the combination of all terminal nodes 36 represents all the entries 14.

The statistically predictive segmentation model 24 creates and splits nodes 24 in a generally conventional manner, as is known in the art. When utilizing the CHAID technique, the model 24 first generates a plurality of predictor categories from the predictor variables, referenced at step 110 in FIG. 5, such that a predictor category is formed for each type of coded indicator. For instance, as in the above example, if each entry is coded with an indicator representing activity in a symphony, a jazz concert, and a family concert, a predictor category would be formed for a symphony activity, a jazz concert activity, and a family concert activity. Thus, a greater number of predictor categories are formed by using a greater number of indicators.

Second, each predictor variable is cycled through to determine for each predictor variable the pair of predictor categories that are least different with respect to the indicator relating to the desired characteristic, as is referenced at step 112 in FIG. 5. The difference is determined by using a Chi-square test or an F-Test, depending on the nature of the coded entry information (i.e. continuous or non-continuous). If the difference is not significant, the predictor categories are merged. If the difference is significant, then the method computes a p-value for the set of categories for the respective predictor.

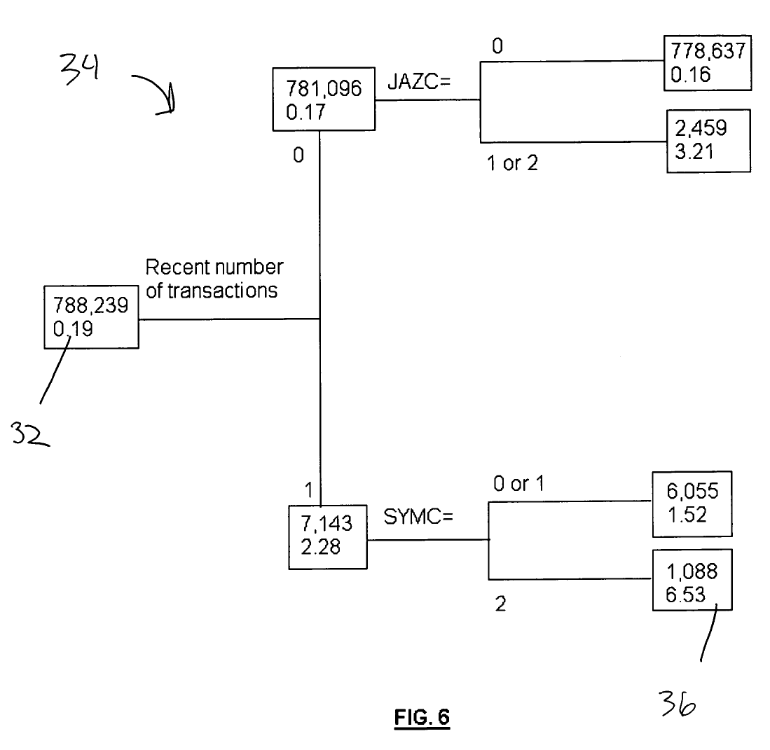

Third, a split variable having the smallest p-value is chosen based on the predictor variable which will yield the most significant split, as is referenced at step 114 in FIG. 5. A node is created by performing a split based on the split variable. If the smallest p-value for any predictor is greater than an alpha-to-split value, then no further splits are preformed. Thus, a node with a p-value for any predictor that is greater than the alpha-to-split value is a terminal node 36. These three steps are repeated until only terminal nodes 36 exist, as is referenced at step 116 in FIG. 6. Thus, each entry is categorized into a group by its placement in at least one terminal node and the specific estimate value 32 for each entry is determined based on the entry's placement in a particular terminal node.

Exhaustive CHAID uses a similar algorithm with the exception that the categories are merged without relying on an alpha-to-merge value until only two categories remain for each predictor. Thus, Exhaustive CHAID requires a substantial amount of additional computing time as compared to CHAID.

The statistically predictive segmentation model 24 may utilize algorithms different than described above or use a modified version of the above algorithms. For instance, the CHAID and Exhaustive CHAID algorithm may be modified to include different or additional steps than those described above and still fall within the scope of the invention, provided the modified algorithms utilize the coded entry information as the predictor variable (the dependent variable) to create the specific estimate value 32 (the independent variable) for each entry based on the indicator 28 relating to the desired characteristic.

Preferably, the model 24 additionally utilizes a rule set to control the formation of the nodes 34. For instance, the rule set may allow the model 24 to create a node only if the node includes a minimum number of entries 14, for example at least 2,000 entries, allow a node to split only if the node contains a minimum number of entries 14, for example at least 665 entries, or require a minimum level of distinction between two nodes before the two nodes are split, for example at least a 95% distinction.

The purpose of the rule set is to make certain that each terminal node 36 is large enough to conform to known statistical principals, such as that the entries included in each node are likely to be in line with statistical expectations. The rule set also ensures that the total number of nodes 34 is manageable, such that each node may be easily selected, viewed, or tracked. For instance, if the number of entries contained in each node was limited, such as to one entry per node, the list of all nodes 34 could be of such substantial length that it would be difficult to identify or manage any single node. Additionally, the rule set ensures that the number of entries within each node is sufficient to prevent the characteristic of a single entry from incorrectly reflecting the characteristics of the entire node. Thus, rules in addition to those described above may be included to fulfill the purpose of the rule set.

Referring to FIG. 6, a sample output of the segmentation model is shown. In this example, it can be seen that the model begins with 788,239 entries 20. The 788,239 entries 20 have a combined previous subscription rate (the specific estimate value 38) of 0.19%. The desired characteristic for this example is a combined previous subscription rate of at least 5%. Using the coded entries and the rule set, the model 24 first splits the plurality of entries 14 into two nodes, using the procedure described above, based on the number of recorded transactions for each entry. The first node, the entries with zero recorded transactions, has 781,096 entries and a previous subscription rate of 0.17%. The second node, the entries with at least one recorded transaction, has 7,143 entries and a previous subscription rate of 2.28%.

Next, the model 24 splits the first and second node, using the procedure described above, based on the number of times each entry has participated in the symphony and the jazz concert into four total nodes. As it can be seen, the node corresponding to entries with at least one recorded participation and two participations in the symphony has 1,088 entries with a previous subscription rate of 6.53%. Thus, the node with at least one recent participation and two participations in the symphony is one group which includes the desired characteristic.

In addition to calculating a specific estimate value corresponding to a specific response rate for each node and entry, such as 6.53% from the above example, the model 24 may determine a specific estimate value corresponding to an average sale or donation value for each node and entry, such as $50. Furthermore, the model 24 may determine a combination value based on the response rate and donation value to predict the amount of money each entry in a node can be expected to donate. For example, if the model 24 predicts a node to have a 6.53% predicted response rate and a $50 average order or donation, the predicted value for each member of the node would be $3.27.

In operation, the model 24 would continue to split nodes, as described above, based on the algorithm and rule set and not be limited to the two iterations shown in FIG. 6, which is used for demonstration purposes only. Thus, it is preferable for the number of identifiers and the number of entries 14 to be maximized to allow the model 24 to provide the most accurate segmentation of the entries 14 possible.

The method or computer program may automatically identify which nodes 34 have the desired characteristic, such as by generating a list, table, spreadsheet, or other data format, including only the nodes 34 having the desired characteristic. The method or computer program may also generate a listing of all the nodes 34 and relevant data to allow a user to identify nodes having the desired characteristic. For instance, in the above example, the method or computer program may automatically identify the node corresponding to entries with at least one recent participation and two participations in the symphony as meeting the desired characteristic or a listing may be generated including all nodes 34 and their corresponding previous subscription rate to allow the user to determine which nodes have the desired characteristic of a 5% previous subscription rate. Furthermore, the listing may allow the identification of the groups that lack the desired characteristic, such that the groups that lack the desired characteristic may be removed from any further communication.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention,

1. A method for efficiently identifying at least one group having a desired characteristic, comprising:
accessing a plurality of entries;
coding each entry with a first identifier representing the number of times the entry has participated in an activity;
coding each entry with a second identifier representing the recency of the entry's participation in the activity;
utilizing a statistically predictive segmentation model to categorize the entries into groups based on the coding of the entries; and
identifying which group includes a desired characteristic based on the categorization of the groups.

2. The method set forth in claim 1, wherein the first identifier represents the number of times the entry has participated in a plurality of activities.

3. The method set forth in claim 2, wherein the second identifier represents the recency of the entry's participation in the plurality of activities.

4. The method set forth in claim 1, wherein each entry includes contact data.

5. The method set forth in claim 4, wherein the contact data comprises an indication of the entry's participation in a plurality of activities, the number of times the entry has participated in each activity, and the recency of the entry's participation each activity.

6. The method as set forth in claim 1, wherein at least one part of the method is implemented by a computer program stored on a computer-readable medium for operating a host computer.

7. The method as set forth in claim 1, wherein the statistically predictive segmentation model is selected from the group consisting of: Chi-Square Automatic Interaction Detection (CHAID); Exhaustive CHAID; and Classification and Regression Tree (C&RT).

8. The method as set forth in claim 1, wherein each entry is coded with a third identifier representing the amount the entry has spent on the activity.

9. The method as set forth in claim 1, wherein each entry is coded with a third identifier representing the entry's demographic data.

10. The method as set forth in claim 9, wherein the demographic data is selected from the group consisting of: the entry's age; the entry's income; the entry's geographic location, and the entry's gender.

11. The method as set forth in claim 1, wherein the statistically predictive segmentation model categorizes the entries into groups based on the coding of the entries and a rule set.

12. A method for efficiently identifying at least one group having a desired characteristic, comprising:
accessing a database including a plurality of entries having contact data;
coding each entry with a plurality of first identifiers representing the number of times the entry has participated in a plurality of activities;
coding each entry with a plurality of second identifiers representing the recency of the entry's participation in the plurality of activities;
utilizing a statistically predictive segmentation model to categorize the entries into groups based on the coding of the entries; and
identifying which group includes a desired characteristic based on the categorization of the groups.

13. The method set forth in claim 12, wherein the contact data comprises an indication of each entry's participation in a plurality of activities, the number of times each entry has participated in each activity, and the recency of each entry's participation each activity.

14. The method as set forth in claim 12, wherein at least one part of the method is implemented by a computer program stored on a computer-readable medium for operating a host computer.

15. The method as set forth in claim 12, wherein the statistically predictive segmentation model is selected from the group consisting of: Chi-Square Automatic Interaction Detection (CHAID); Exhaustive CHAID; and Classification and Regression Tree (C&RT).

16. The method as set forth in claim 12, wherein each entry is coded with a third identifier representing the amount the entry has spent on the activities.

17. The method as set forth in claim 16, wherein each entry is coded with a fourth identifier representing the total number of activities the entry has participated in.

18. The method as set forth in claim 17, wherein each entry is coded with a fifth identifier representing the entry's demographic data, wherein the demographic data is selected from the group consisting of: the entry's age; the entry's income; the entry's geographic location, and the entry's gender.

19. The method as set forth in claim 12, wherein the statistically predictive segmentation model categorizes the entries into groups based on the coding of the entries and a rule set.

20. A method for efficiently identifying at least one group having a desired characteristic, comprising:
accessing a database having a plurality of entries, wherein each entry includes contact data comprising
the number of times the entry has participated in a plurality of activities;
the number of times the entry has participated in each activity, and
the recency of the entry's participation each activity;
coding each entry with a plurality of first identifiers representing the number of times the entry has participated in each activity;
coding each entry with a plurality of second identifiers representing the recency of the entry's participation in each activity;
utilizing a statistically predictive segmentation model to create a plurality of groups by segmenting the entries based on the coding of the entries; and
identifying which group includes a desired characteristic based on the categorization of the groups.

21. The method as set forth in claim 20, wherein the statistically predictive segmentation model is selected from the group consisting of: Chi-Square Automatic Interaction Detection (CHAID); Exhaustive CHAID; and Classification and Regression Tree (C&RT).

22. The method as set forth in claim 20, wherein at least one part of the method is implemented by a computer program stored on a computer-readable medium for operating a host computer.

23. The method as set forth in claim 20, wherein each entry is coded with a plurality of third identifiers representing the amount the entry has spent on each activity.

24. The method as set forth in claim 23, wherein each entry is coded with a plurality of fourth identifiers representing the number of times the entry has participated in the plurality of activities.

25. The method as set forth in claim 24, wherein each entry is coded with a plurality of fifth identifiers representing the entry's demographic data, wherein the demographic data is selected from the group consisting of: the entry's age; the entry's income; the entry's geographic location, and the entry's gender.

26. The method as set forth in claim 25, wherein the statistically predictive segmentation model categorizes the entries into groups based on the coding of the entries and a rule set.

27. A method for efficiently identifying at least one group having a desired characteristic, comprising:
accessing a database including a plurality of entries, wherein each entry includes contact data comprising
the number of times the entry has participated in a plurality of activities;
the number of times the entry has participated in each activity,
the recency of the entry's participation in each activity,
the amount spent by the entry on each activity, and
demographic data;
coding each entry with a plurality of first identifiers representing the number of times the entry has participated in each activity;
coding each entry with a plurality of second identifiers representing the recency of the entry's participation in each activity;
utilizing a statistically predictive segmentation model to create a plurality of groups by segmenting the entries based on the coding of the entries and a rule set; and
identifying which groups have a desired characteristic based on the categorization of the groups.

28. The method as set forth in claim 27, wherein the statistically predictive segmentation model is selected from the group consisting of: Chi-Square Automatic Interaction Detection (CHAID); Exhaustive CHAID; and Classification and Regression Tree (C&RT).

29. The method as set forth in claim 27, wherein at least one part of the method is implemented by a computer program stored on a computer-readable medium for operating a host computer.

30. The method as set forth in claim 27, wherein the desired characteristic is a minimum percentage of previous purchases by the entries within each group.

31. The method as set forth in claim 27, wherein the desired characteristic is a minimum percentage of previous subscriptions by the entries within each group.

32. The method as set forth in claim 27, wherein each entry is coded with a plurality of third identifiers representing the amount the entry has spent on each activity.

33. The method as set forth in claim 32, wherein each entry is coded with a plurality of fourth identifiers representing the number of times the entry has participated in the plurality of activities.

34. The method as set forth in claim 33, wherein each entry is coded with a plurality of fifth identifiers representing the entry's demographic data, wherein the demographic data is selected from the group consisting of: the entry's age;
the entry's income; the entry's geographic location, and the entry's gender.

35. A computer program stored on a computer-readable medium for operating a host computer, the computer program comprising:
a code segment executed by the host computer for accessing a database including a plurality of entries having contact data;
a code segment executed by the host computer for coding each entry with a first identifier representing the number of times the entry has participated in an activity;
a code segment executed by the host computer for coding each entry with a second identifier representing the recency of the entry's participation in the activity; and
a code segment executed by the host computer utilizing a statistically predictive segmentation model to group the entries based on the coding of the entries and determine which group includes a desired characteristic based on the categorization of the groups.

36. The computer program as set forth in claim 35, wherein the statistically predictive segmentation model is selected from the group consisting of: Chi-Square Automatic Interaction Detection (CHAID); Exhaustive CHAID; and Classification and Regression Tree (C&RT).

37. The computer program as set forth in claim 35, wherein the first identifier represents the number of times the entry has participated in a plurality of activities.

38. The computer program as forth in claim 35, wherein the second identifier represents the recency of the entry's participation in the plurality of activities.

39. The computer program as set forth in claim 35, wherein each entry includes contact data.

40. The computer program as set forth in claim 39, wherein the contact data comprises an indication of the entry's participation in a plurality of activities, the number of times the entry has participated in each activity, and the recency of the entry's participation each activity.

41. The computer program as set forth in claim 35, wherein the statistically predictive segmentation model categorizes the entries into groups based on the coding of the entries and a rule set.
